(19) United States
(12) Patent Application Publication
(10) Pub. No.: US 2013/0205171 A1
(43) Pub. Date: Aug. 8, 2013

(54) FIRST AND SECOND MEMORY CONTROLLERS FOR RECONFIGURABLE COMPUTING APPARATUS, AND RECONFIGURABLE COMPUTING APPARATUS CAPABLE OF PROCESSING DEBUGGING TRACE DATA

(71) Applicant: Samsung Electronics Co., Ltd., Suwon-si (KR)

(72) Inventor: Jin-Sae Jung, Yongin-si (KR)

(73) Assignee: SAMSUNG ELECTRONICS CO., LTD., Suwon-si (KR)

(21) Appl. No.: 13/761,431

(22) Filed: Feb. 7, 2013

(30) Foreign Application Priority Data
Feb. 7, 2012 (KR) 10-2012-0012392

(51) Int. Cl. G06F 11/26

(52) U.S. Cl. CPC G06F 11/26
USPC 714/37

(57) ABSTRACT

An apparatus and a method for processing debugging trace data for a reconfigurable computing apparatus take advantage of a first mode and a second mode of the reconfigurable computing apparatus being mutually exclusive, wherein first instructions associated with a loop operation are executed in the first mode, and second instructions associated with a general operation other than the loop operation that can be processed in parallel are executed in the second mode, so that, without the need for an additional memory, debugging trace data can be efficiently stored using a first memory configured to store configuration information for use in configuring a connection path between processing elements arranged in a reconfigurable unit in the first mode, and a second memory from which an instruction word including a plurality of the second instructions is fetched in the second mode.

### CROSS-REFERENCE TO RELATED APPLICATIONS

This application claims the benefit under 35 USC 119(a) of Korean Patent Application No. 10-2012-0012392 filed on Feb. 7, 2012, in the Korean Intellectual Property Office, the entire disclosure of which is incorporated herein by reference for all purposes.

### BACKGROUND

1. Field

The following description relates to a reconfigurable computing apparatus, and to an apparatus and method for processing debugging trace data for a reconfigurable computing apparatus.

2. Description of Related Art

Reconfigurable architecture refers to a reconfigurable hardware configuration for a computing apparatus for processing instructions. Such a configuration combines advantages of hardware for achieving quick operation speed, and advantages of software for allowing flexibility in executing a multiplicity of operations.

The reconfigurable architecture provides excellent performance in loop operations in which the same operations are iteratively executed. Also, the reconfigurable architecture provides improved performance, for instance, when it is combined with pipelining that achieves high-speed processing by allowing overlapping executions of operations.

### SUMMARY

In one general aspect, a first memory controller for a reconfigurable computing apparatus is configured to, in a first mode of the reconfigurable computing apparatus in which first instructions associated with a loop operation are executed by a processor, read configuration information from a first memory, the configuration information being used to configure a connection path between processing elements of a reconfigurable unit; and store debugging trace data in a second memory configured to have fetched therefrom an instruction word including a plurality of second instructions that can be processed in parallel in a second mode of the reconfigurable computing apparatus in which the second instructions are executed by the processor.

The second instructions may be associated with a general operation other than the loop operation; and the first memory controller may include a mode determining unit configured to determine whether the reconfigurable computing apparatus is operating in the first mode or the second mode; a first memory accessing unit configured to, in response to the mode determining unit determining that the reconfigurable computing apparatus is operating in the first mode, be activated and access the first memory to read the configuration information from the first memory; and a second memory accessing unit configured to, in response to the mode determining unit determining that the reconfigurable computing apparatus is operating in the first mode, be activated and access the second memory to store the debugging trace data in the second memory.

The first memory accessing unit may be further configured to be deactivated in response to the mode determining unit determining that the reconfigurable computing apparatus is operating in the second mode.

The second memory accessing unit may be further configured to be deactivated in response to the mode determining unit determining that the reconfigurable computing apparatus is operating in the second mode.

The first memory controller may further include a data output unit configured to select from the second memory debugging trace data chosen by a debugging apparatus, and output the selected debugging trace data to the debugging apparatus.

In another general aspect, a second memory controller for a reconfigurable computing apparatus is configured to, in a second mode of the reconfigurable computing apparatus in which second instructions associated with a general operation other than a loop operation that can be processed in parallel are executed by a processor, fetch an instruction word including a plurality of the second instructions that can be processed in parallel from a second memory; and store debugging trace data in a first memory configured to store configuration information used to configure a connection path between processing elements of a reconfigurable unit in a first mode of the reconfigurable computing apparatus in which first instructions are executed by the processor.

The first instructions may be associated with the loop operation; and the second memory controller may include a mode determining unit configured to determine whether the reconfigurable computing apparatus is operating in the first mode or the second mode; a second memory accessing unit configured to, in response to the mode determining unit determining that the reconfigurable computing apparatus is operating in the second mode, be activated and access the second memory to fetch the instruction word including the plurality of the second instructions that can be processed in parallel from the second memory; and a first memory accessing unit configured to, in response to the mode determining unit determining that the reconfigurable computing apparatus is operating in the second mode, be activated and access the first memory to store the debugging trace data in the first memory.

The second memory accessing unit may be further configured to be deactivated in response to the mode determining unit determining that the reconfigurable computing apparatus is operating in the first mode.

The first memory accessing unit may be further configured to be deactivated in response to the mode determining unit determining that the reconfigurable computing apparatus is operating in the first mode.

The second memory controller may further include a data output unit configured to select from the first memory debugging trace data chosen by a debugging apparatus, and output the selected debugging trace data to the debugging apparatus.

In another general aspect, a reconfigurable computing apparatus capable of processing debugging trace data includes a processor configured to switch between a first mode of the reconfigurable computing apparatus and a second mode of the reconfigurable computing apparatus, wherein in the first mode, first instructions associated with a loop operation are executed, and in the second mode, second instructions associated with a general operation other than the loop operation that can be processed in parallel are executed; a reconfigurable unit including a plurality of processing elements configured to execute the first instructions in the first mode and execute the second instructions in the second mode, the execution of the first instructions being mutually exclusive with the execution of the second instructions; a first memory configured to store configuration information for use in configuring a connection path between the processing elements of the reconfigurable unit in the first mode; a second memory configured to have an instruction word fetched therefrom in the second mode, the instruction word including a plurality of the second instructions associated with the general operation other than the loop operation that can be processed in parallel; a first memory controller configured to, in response to the processor switching to the first mode, read the configuration information from the first memory, and store the debugging trace data in the second memory; and a second memory controller configured to, in response to the processor switching to the second mode, fetch the instruction word from the second memory, and store the debugging trace data in the first memory.

The first memory controller may include a mode determining unit configured to determine whether the reconfigurable computing apparatus is operating in the first mode or the second mode; a first memory accessing unit configured to, in response to the mode determining unit determining that the reconfigurable computing apparatus is operating in the first mode, be activated and access the first memory to read the configuration information from the first memory; and a second memory accessing unit configured to, in response to the mode determining unit determining that the reconfigurable computing apparatus is operating in the first mode, be activated and access the second memory to store the debugging trace data in the second memory.

The first memory accessing unit may be further configured to be deactivated in response to the mode determining unit determining that the reconfigurable computing apparatus is operating in the second mode.

The second memory accessing unit may be further configured to be deactivated in response to the mode determining unit determining that the reconfigurable computing apparatus is operating in the second mode.

The first memory controller may further include a data output unit configured to select from the second memory debugging trace data chosen by a debugging apparatus, and output the selected debugging trace data to the debugging apparatus.

The second memory controller may include a mode determining unit configured to determine whether the reconfigurable computing apparatus is operating in the first mode or the second mode; a second memory accessing unit configured to, in response to the mode determining unit determining that the reconfigurable computing apparatus is operating in the second mode, be activated and access the second memory to fetch the instruction word including the plurality of the second instructions associated with the general operation other than the loop operation that can be processed in parallel from the second memory; and a first memory accessing unit configured to, in response to the mode determining unit determining that the reconfigurable computing apparatus is operating in the second mode, be activated and access the first memory to store the debugging trace data in the first memory.

The second memory accessing unit may be further configured to be deactivated in response to the mode determining unit determining that the reconfigurable computing apparatus is operating in the first mode.

The first memory accessing unit may be further configured to be deactivated in response to the mode determining unit determining that the reconfigurable computing apparatus is operating in the first mode.

The second memory controller may further include a data output unit configured to select from the first memory debugging trace data chosen by a debugging apparatus, and output the debugging trace data to the debugging apparatus.

In another general aspect, a method of processing debugging trace data in a reconfigurable computing apparatus includes, in a first mode of the reconfigurable computing apparatus, storing debugging trace data generated by execution of first instructions in the first mode of the reconfigurable computing apparatus in a second memory configured to store an instruction word including a plurality of second instructions in a second mode of the reconfigurable computing apparatus; and, in the second mode of the reconfigurable computing apparatus, storing debugging trace data generated by execution of the second instructions in the second mode of the reconfigurable computing apparatus in a first memory configured to store configuration information for use in configuring a connection path between processing elements of a reconfigurable unit in the first mode.

The first instructions may be associated with a loop operation; and the second instructions may be associated with a general operation other than the loop operation and can be processed in parallel.

The reconfigurable computing apparatus may switch between the first mode and the second mode; the method may further include determining whether the reconfigurable computing apparatus is operating in the first mode or the second mode; the storing of the debugging trace data in the second memory may be performed in response to a result of the determining being that the reconfigurable computing apparatus is operating in the first mode; and the storing of the debugging trace data in the first memory may be performed in response to a result of the determining being that the reconfigurable computing apparatus is operating in the second mode.

Other features and aspects will be apparent from the following detailed description, the drawings, and the claims.

### BRIEF DESCRIPTION OF THE DRAWINGS

FIG. 1 is a diagram illustrating an example of a first memory controller for a reconfigurable computing apparatus.

FIG. 2 is a diagram illustrating an example of a second memory controller for a reconfigurable computing apparatus.

FIG. 3 is a diagram illustrating an example of a reconfigurable computing apparatus capable of processing debugging trace data.

FIG. 4 is a flowchart illustrating an example of a method of processing debugging trace data of the reconfigurable computing apparatus shown in FIG. 3.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

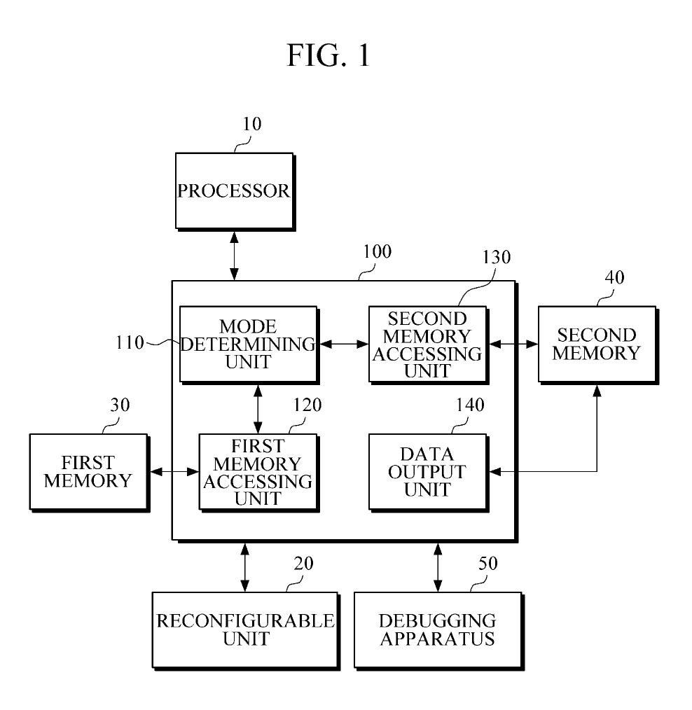

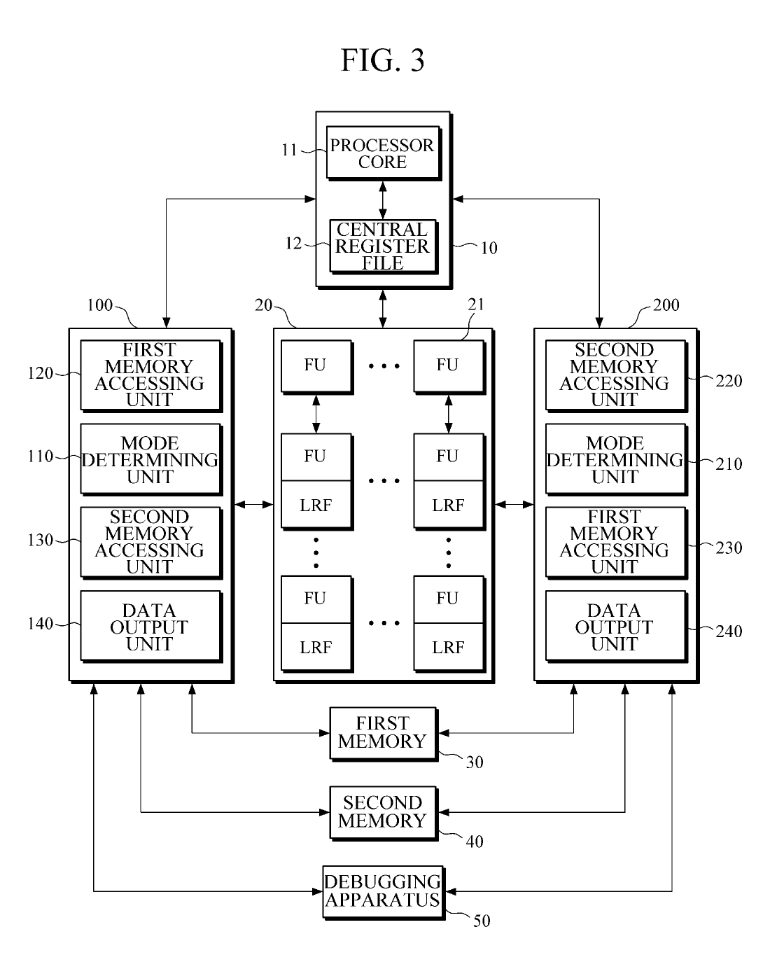

FIG. 1 is a diagram illustrating an example of a first memory controller for a reconfigurable computing apparatus. Referring to FIG. 1, a first memory controller 100 for a reconfigurable computing apparatus reads configuration information stored in a first memory 30 to configure a connection path between processing elements (not shown in FIG. 1, but shown in FIG. 3) of a reconfigurable unit 20 in a first mode in which first instructions associated with a loop operation are executed by a processor 10. In addition, the first memory controller 100 stores debugging trace data in a second memory 40 from which an instruction word that includes a plurality of second instructions associated with a general operation other than the loop operation that can be processed in parallel is fetched in a second mode in which the second instructions are executed by the processor 10, and outputs the debugging trace data stored in the second memory 40 to a debugging apparatus 50.

As shown in FIG. 1, the first memory controller 100 for a reconfigurable computing apparatus includes a mode determining unit 110, a first memory accessing unit 120, a second memory accessing unit 130, and a data output unit 140.

The mode determining unit 110 determines whether the reconfigurable computing apparatus is operating in the first mode for executing the first instructions associated with the loop operation, or in the second mode for executing the second instructions associated with the general operation other than the loop operation.

The processor 10 switches between the first mode for executing the first instructions associated with the loop operation and the second mode for executing the second instructions associated with the general operation other than the loop operation, executes the first instructions in the first mode, and executes the second instructions in the second mode.

The mode determining unit 110 determines whether the reconfigurable computing apparatus is operating in the first mode or the second mode by detecting whether the first instructions or the second instructions are being executed by the processor 10.

In response to the mode determining unit 110 determining that the reconfigurable computing apparatus is operating in the first mode, the first memory accessing unit 120 is activated and accesses the first memory 30 to read configuration information for use in configuring the connection path between the processing elements of the reconfigurable unit 20. On the contrary, in response to the mode determining unit 110 determining that the reconfigurable computing apparatus is operating in the second mode, the first memory accessing unit 120 is deactivated.

Based on the configuration information read from the first memory 30, the reconfigurable unit 20 configures the connection path between the processing elements of the reconfigurable unit 20, and the processing elements execute the first instructions associated with the loop operation.

In response to the mode determining unit 110 determining that the reconfigurable computing apparatus is operating in the first mode, the second memory accessing unit 130 is activated and accesses the second memory 40 to store debugging trace data. On the contrary, in response to the mode determining unit 110 determining that the reconfigurable computing apparatus is operating in the second mode, the second memory accessing unit 130 is deactivated.

The debugging trace data stored in the second memory 40 is information generated by executing an application, such as operation results or memory access information, for use in debugging the application, and may be provided to a program developer via the debugging apparatus 50 for use in debugging the application.

The data output unit 140 selects from the second memory 40 debugging trace data chosen by the debugging apparatus 50, and outputs the selected debugging trace data to the debugging apparatus 50.

For example, if debugging trace data for a given application is stored in the second memory 40 when the application is executed, and if a program developer of the application connects the debugging apparatus 50 to the data output unit 140 and requests the debugging trace data, the data output unit 140 outputs the debugging trace data stored in the second memory 40 to the debugging apparatus 50.

When there is a large amount of debugging trace data stored in the second memory 40, outputting all of the debugging trace data to the debugging apparatus 50 may be inefficient because it may waste hardware or software resources. Thus, the data output unit 140 may be configured to select from the second memory 40 only the debugging trace data chosen by the debugging apparatus 50, and output the selected debugging trace data to the debugging apparatus 50.

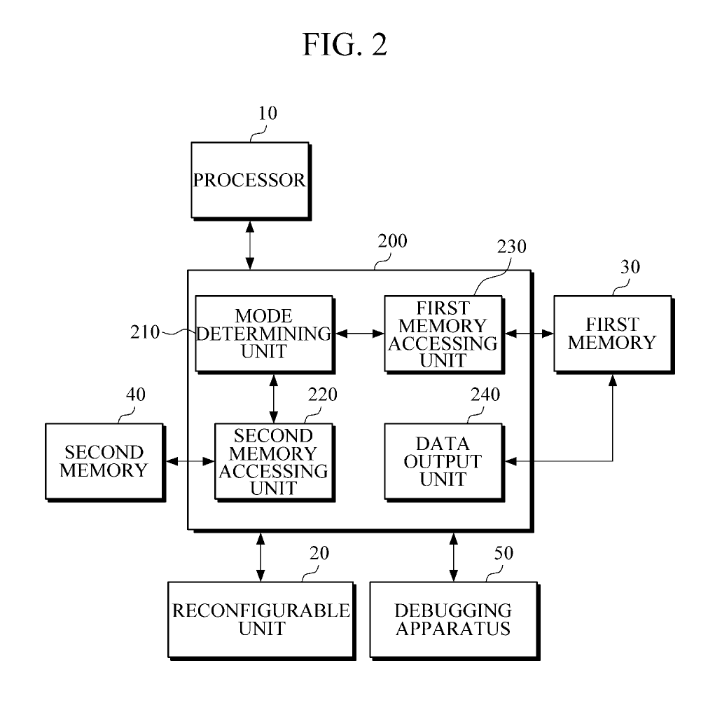

FIG. 2 is a diagram illustrating an example of a second memory controller for a reconfigurable computing apparatus. A second memory controller for a reconfigurable computing apparatus fetches an instruction word from a second memory 40, the instruction word including a plurality of second instructions associated with a general operation other than a loop operation that can be processed in parallel, stores debugging trace data in a first memory 30 that stores configuration information for use in configuring a connection path between processing elements (not shown in FIG. 2, but shown in FIG. 3) of a reconfigurable unit 20 in a second mode in which the second instructions associated with the general operation other than the loop operation are executed by a processor 10, and outputs the debugging trace data stored in the first memory 40 to a debugging apparatus 50.

As shown in FIG. 2, the second memory controller 200 for a reconfigurable computing apparatus includes a mode determining unit 210, a second memory accessing unit 220, a first memory unit 230, and a data output unit 240.

The mode determining unit 210 determines whether the reconfigurable computing apparatus is operating in a first mode for executing first instructions associated with the loop operation, or the second mode for executing the second instructions associated with the general operation other than the loop operation.

The processor 10 switches between the first mode and the second mode, executes the first instructions in the first mode, and executes the second instructions in the second mode.

The mode determining unit 210 determines whether the reconfigurable computing apparatus is operating in the first mode or the second mode by detecting whether the first instructions or the second instructions are being executed by the processor 10.

In response to the mode determining unit 210 determining that the reconfigurable computing apparatus is operating in the second mode, the second memory accessing unit 220 is activated and accesses the second memory 40 to fetch the instruction word including the plurality of second instructions associated with the general operation other than the loop operation that can be processed in parallel. On the contrary, in response to the mode determining unit 210 determining that the reconfigurable computing apparatus is operating in the first mode, the second memory accessing unit 220 is deactivated.

The processing elements of the reconfigurable unit 20 execute the second instructions of the instruction word fetched from the second memory 40 by processing the second instructions in parallel.

In response to the mode determining unit 210 determining that the reconfigurable computing apparatus is operating in the second mode, the first memory accessing unit 230 is activated and accesses the first memory 30 to store the debugging trace data. On the contrary, in response to the mode determining unit 210 determining that the reconfigurable computing apparatus is operating in the first mode, the first memory accessing unit 230 is deactivated.

The debugging trace data stored in the first memory is information generated by executing an application, such as operation results or memory access information, for use in debugging the application, and may be provided to a program developer via a debugging apparatus 50 for use in debugging the application.

The data output unit 240 selects from the first memory 30 debugging trace data chosen by the debugging apparatus 50, and outputs the selected debugging trace data to the debugging apparatus 50.

For example, if debugging trace data for a given application is stored in the first memory 30 when the application is executed, and if a program developer of the application connects a debugging apparatus 50 to the data output unit 240 and requests the debugging trace data, the data output unit 240 outputs the debugging trace data stored in the first memory 30 to the debugging apparatus 50.

When there is a large amount of debugging trace data stored in the first memory 30, outputting all of the debugging trace data to the debugging apparatus 50 may be inefficient because it may waste hardware or software resources. Thus, the data output unit 240 may be configured to select from the first memory 30 only the debugging trace data chosen by the debugging apparatus 50, and output the selected debugging trace data to the debugging apparatus 50.

FIG. 3 is a diagram illustrating an example of a reconfigurable computing apparatus capable of processing debugging trace data. Elements of the first memory controller 100 shown in FIG. 1 and the second memory controller 200 shown in FIG. 2 and relationships therebetween will now be described in detail with reference to FIG. 3.

Referring to FIG. 3, a reconfigurable computing apparatus includes a processor 10, a reconfigurable unit 20, a first memory 30, a second memory 40, a debugging apparatus 50, a first memory controller 100, and a second memory controller 200.

The processor 10 switches between a first mode and a second mode, and includes a processor core 11 and a central register file 12. In the first mode, first instructions associated with a loop operation are executed, and in the second mode, second instructions associated with a general operation other than the loop operation are executed.

In the first mode, the processor core 11 executes the first instructions associated with the loop operation using processing elements 21 of the reconfigurable unit 20. The reconfigurable unit 20 configures a connection path between the processing elements 21 based on configuration information stored in the first memory 30.

In the second mode, the processor core 11 fetches an instruction word including a plurality of second instructions associated with the general operation other than the loop operation that can be processed in parallel from the second memory 40, and executes the second instructions of the instruction word in parallel using the processing elements 21 of the reconfigurable unit 20.

The central register file 12 stores various types of data required for the processing elements 21 to execute the first instructions and the second instructions, and results of executing the first instructions and the second instructions.

The processor 10 compiles an application written in a high-level language, creates configuration information for configuring the connection path between the processing elements 21 of the reconfigurable unit 20 by scheduling compiled instructions, and stores the created configuration information in the first memory 30.

The reconfigurable unit 20 includes the plurality of processing elements 21 connected together via the connection path for executing the first instructions or the second instructions that are mutually exclusively executed in the first mode or the second mode. In the first mode, the reconfigurable unit 20 configures the connection path between the processing elements 21 based on the configuration information stored in the first memory 30.

For example, the reconfigurable unit 20 may be a coarse grained array (CGA). A CGA includes a plurality of processing units, each consisting of a function unit (FU) and a local register file (LRF), and processing elements connected to the central register file 12 that include only a function unit (FU).

The first memory 30 stores configuration information for use in configuring the connection path between the processing elements 21 of the reconfigurable unit 20. In the first mode, the reconfigurable unit 20 configures the connection path between the processing elements 21 based on the configuration information stored in the first memory 30.

The second memory 40 stores an instruction word including a plurality of the second instructions associated with the general operation other than the loop operation that can be processed in parallel. In the second mode, the processing elements 21 of the reconfigurable unit 20 process the second instructions of the instruction word fetched from the second memory 40 in parallel.

In the first mode in which the first instructions associated with the loop operation are executed by the processor 10, the first memory controller 100 reads the configuration information for use in configuring the connection path between the processing elements 21 of reconfigurable unit 20 from the first memory 30, and stores debugging trace data in the second memory 40 from which the instruction word including the plurality of second instructions associated with the general operation other than the loop operation that can be processed in parallel is fetched in the second mode.

In the second mode in which the second instructions associated with the general operation other than the loop operation are executed by the processor 10, the second memory controller 200 fetches the instruction word including the plurality of second instructions associated with the general operation other than the loop operation that can be processed in parallel from the second memory 40, and stores the debugging trace data in the first memory 30 that stores configuration information for use in configuring the connection path between the processing elements 21 of the reconfigurable unit 20 in the first mode.

The debugging trace data is information generated by executing an application, such as operation results or memory access information, for use in debugging the application, and may be provided to a program developer via the debugging apparatus 50 for use in debugging the application.

If an additional memory is added to store the debugging trace data, a manufacturing cost for the reconfigurable computing apparatus is consequently raised and its size is increased. Thus, to avoid such drawbacks, the reconfigurable computing apparatus shown in FIG. 3 stores the debugging trace data effectively without adding an additional memory by taking advantage of the face that the first mode and the second mode are activated mutually exclusively, not simultaneously, thereby contributing to implementing a compact design for the reconfigurable computing apparatus.

Because the first mode for executing the first instructions associated with a loop operation and the second mode for executing the second instructions associated with a general operation other than the loop operation are mutually exclusively enabled, in the first mode, the first memory controller 100 stores the debugging trace data in the second memory 40 that is unused during the first mode and, and in the second mode, the second memory controller 200 stores the debugging trace data in the first memory 30 that is unused during the second mode.

In this manner, the reconfigurable computing apparatus is able to effectively store the debugging trace data by using the first memory 30 that stores the configuration information for use in configuring the connection path between the processing elements 21 of the reconfigurable unit 20 in the first mode, and the second memory 40 from which the instruction word including the plurality of second instructions associated with the general operation other than the loop operation that can be processed in parallel is fetched in the second mode, without using an additional memory for storing the debugging trace data, so that the reduction of manufacturing cost and the implementation of a compact design can be achieved.

In the example in FIG. 3, the first memory controller 100 for a reconfigurable computing apparatus capable of processing debugging trace data includes a mode determining unit 110, a first memory accessing unit 120, a second memory accessing unit 130, and a data output unit 140.

The mode determining unit 110 determines whether the reconfigurable computing apparatus is operating in the first mode for executing the first instructions associated with the loop operation, or in the second mode for executing the second instructions associated with the general operation other than the loop operation.

The processor 10 switches between the first mode and the second mode, executes the first instructions in the first mode, and executes the second instructions in the second mode.

The mode determining unit 110 determines whether the reconfigurable computing apparatus is operating in the first mode or the second mode by detecting whether the first instructions or the second instructions are being executed by the processor 10.

In response to the mode determining unit 110 determining that the reconfigurable computing apparatus is operating in the first mode, the first memory accessing unit 120 is activated and accesses the first memory to read the configuration information for use in configuring the connection path between the processing elements 21 of the reconfigurable unit 20. On the contrary, in response to the mode determining unit 110 determining that the reconfigurable computing apparatus is operating in the second mode, the first memory accessing unit 120 is deactivated.

Based on the configuration information read from the first memory 30, the reconfigurable unit configures the connection path between the processing elements 21 of the reconfigurable unit 20, and the processing elements 21 execute the first instructions associated with the loop operation.

In response to the mode determining unit 110 determining that the reconfigurable computing apparatus is operating in the first mode, the second memory accessing unit 130 is activated, and accesses the second memory 40 to store the debugging trace data. On the contrary, in response to the mode determining unit 110 determining that the reconfigurable computing apparatus is operating in the second mode, the second memory accessing unit 130 is deactivated.

The debugging trace data stored in the second memory 40 is information generated by executing an application, such as operation results or memory access information, for use in debugging the application, and may be provided to a program developer via the debugging apparatus 50 for use in debugging the application.

The data output unit 140 selects from the second memory 40 debugging trace data chosen by the debugging apparatus 50, and outputs the selected debugging trace data to the debugging apparatus 50.

For example, if debugging trace data for a given application is stored in the second memory 40 when the application is executed, and if a program developer of the application connects the debugging apparatus 50 to the data output unit 140 and requests the debugging trace data, the data output unit 140 outputs the debugging trace data stored in the second memory 40 to the debugging apparatus 50.

When there is a large amount of debugging trace data stored in the second memory 40, outputting all of the debugging trace data to the debugging apparatus 50 may be inefficient because it may waste hardware or software resources. Thus, the data output unit 140 may be configured to select from the second memory 40 only the debugging trace data chosen by the debugging apparatus 50, and output the selected debugging trace data to the debugging apparatus 50.

In the example in FIG. 3, the second memory controller 200 includes a mode determining unit 210, a second memory accessing unit 220, a first memory accessing unit 230, and a data output unit 240.

The mode determining unit 210 determines whether the reconfigurable computing apparatus is operating in the first mode for executing the first instructions associated with the loop operation, or in the second mode for executing the second instructions associated with the general operation other than the loop operation.

The processor 10 switches between the first mode and the second mode, executes the first instructions in the first mode, and executes the second instructions in the second mode.

The mode determining unit 210 determines whether the reconfigurable computing apparatus is operating in the first mode or the second mode by detecting whether the first instructions or the second instructions are being executed by the processor 10.

In response to the mode determining unit 210 determining that the reconfigurable computing apparatus is operating in the second mode, the second memory accessing unit 220 is activated and accesses the second memory 40 to fetch the instruction word including the plurality of second instructions associated with the general operation other than the loop operation that can be processed in parallel. On the contrary, in response to the mode determining unit 210 determining that the reconfigurable computing apparatus is operating in the first mode, the second memory accessing unit 220 is deactivated.

The processing elements 21 of the reconfigurable unit 20 execute the second instructions of the instruction word fetched from the second memory 40 by processing the second instructions in parallel.

In response to the mode determining unit 210 determining that the reconfigurable computing apparatus is operating in the second mode, the first memory accessing unit 230 is activated and accesses the first memory 30 to store the debugging trace data. On the contrary, in response to the mode determining unit 210 determining that the reconfigurable computing apparatus is operating in the first mode, the first memory accessing unit 230 is deactivated.

The debugging trace data stored in the first memory 30 is information generated by executing an application, such as operation results or memory access information, for use in debugging the application, and may be provided to a program developer via the debugging apparatus 50 for use in debugging the application.

The data output unit 240 selects from the first memory 30 debugging trace data chosen by the debugging apparatus 50, and outputs the selected debugging trace data to the debugging apparatus 50.

For example, in the case of large size of the debugging trace data size, outputting all of the debugging trace data to the debugging apparatus 50 may be inefficient because it may waste hardware or software resources. Thus, the data output unit 240 may be configured to select from the first memory 30 only the debugging trace data chosen by the debugging apparatus 50, and output the selected debugging trace data to the debugging apparatus 50.

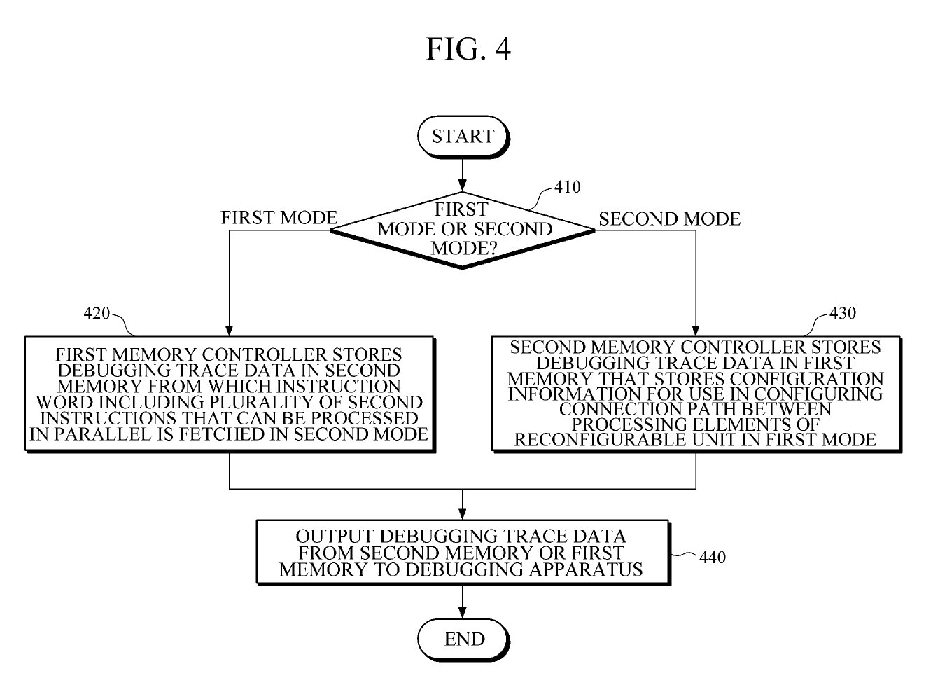

FIG. 4 is a flowchart illustrating an example of a method of processing debugging trace data of the reconfigurable computing apparatus shown in FIG. 3.

A processor of the reconfigurable computing apparatus switches between a first mode and a second mode, wherein in the first mode, first instructions associated with a loop operation are executed, and in the second mode, second instructions associated with a general operation other than the loop operation are executed. Accordingly, in the first mode, the first instructions are executed, and in the second mode, the second instructions are executed.

In operation 410, each of a first memory controller and a second memory controller in the reconfigurable computing apparatus determines whether the reconfigurable computing apparatus is operating in the first mode or the second mode.

In operation 420, in response to the first memory controller and the second memory controller determining in operation 410 that the reconfigurable computing apparatus is operating in the first mode, the first memory controller stores debugging trace data in a second memory from which an instruction word including a plurality of second instructions that can be processed in parallel is fetched in the second mode.

In operation 430, in response to the first memory controller and the second memory controller determining in operation 410 that the reconfigurable computing apparatus is operating in the second mode, the second memory controller stores debugging trace data in a first memory that stores configuration information for use in configuring a connection path between processing elements of a reconfigurable unit in the first mode.

Thereafter, in operation 440, the first memory controller or the second memory controller outputs the debugging trace data from the second memory or the first memory to a debugging apparatus.

Accordingly, without needing an additional memory for storing the debugging trace data, the reconfigurable computing apparatus is able to efficiently store the debugging trace data in the first memory that stores the configuration information for use in configuring the connection path between the processing elements of the reconfigurable unit and in the second memory from which the instruction word including the plurality of second instructions that can be processed in parallel is fetched, enabling the reduction of manufacturing cost and a compact design can be achieved.

The processor 10, the processor core 11, the central register file 12, the reconfigurable unit 20, the functional elements 21, the function units, the local register files, the first memory 30, the second memory 40, the debugging apparatus 50, the memory controller 100, the mode determining unit 110, the first memory accessing unit 120, the second memory accessing unit 130, the data output unit 140, the second memory controller 200, the mode determining unit 210, the second memory accessing unit 220, the first memory accessing unit 230, the data output unit 240 described above may be implemented using one or more hardware components, one or more software components, or a combination of one or more hardware components and one or more software components.

A hardware component may be, for example, a physical device that physically performs one or more operations, but is not limited thereto. Examples of hardware components include arithmetic elements, operational elements, registers, buses, memory devices, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A first memory controller for a reconfigurable computing apparatus, the first memory controller being configured to, in a first mode of the reconfigurable computing apparatus in which first instructions associated with a loop operation are executed by a processor:
read configuration information from a first memory, the configuration information being used to configure a connection path between processing elements of a reconfigurable unit; and
store debugging trace data in a second memory configured to have fetched therefrom an instruction word comprising a plurality of second instructions that can be processed in parallel in a second mode of the reconfigurable computing apparatus in which the second instructions are executed by the processor.

2. The first memory controller of claim 1, wherein the second instructions are associated with a general operation other than the loop operation; and
the first memory controller comprises:
a mode determining unit configured to determine whether the reconfigurable computing apparatus is operating in the first mode or the second mode;
a first memory accessing unit configured to, in response to the mode determining unit determining that the reconfigurable computing apparatus is operating in the first mode, be activated and access the first memory to read the configuration information from the first memory; and
a second memory accessing unit configured to, in response to the mode determining unit determining that the reconfigurable computing apparatus is operating in the first mode, be activated and access the second memory to store the debugging trace data in the second memory.

3. The first memory controller of claim 2, wherein the first memory accessing unit is further configured to be deactivated in response to the mode determining unit determining that the reconfigurable computing apparatus is operating in the second mode.

4. The first memory controller of claim 2, wherein the second memory accessing unit is further configured to be deactivated in response to the mode determining unit determining that the reconfigurable computing apparatus is operating in the second mode.

5. The first memory controller of claim 2, further comprising a data output unit configured to select from the second memory debugging trace data chosen by a debugging apparatus, and output the selected debugging trace data to the debugging apparatus.

6. A second memory controller for a reconfigurable computing apparatus, the second memory controller being configured to, in a second mode of the reconfigurable computing apparatus in which second instructions associated with a general operation other than a loop operation that can be processed in parallel are executed by a processor:
fetch an instruction word comprising a plurality of the second instructions that can be processed in parallel from a second memory; and
store debugging trace data in a first memory configured to store configuration information used to configure a connection path between processing elements of a reconfigurable unit in a first mode of the reconfigurable computing apparatus in which first instructions are executed by the processor.

7. The second memory controller of claim 6, wherein the first instructions are associated with the loop operation; and
the second memory controller comprises:
a mode determining unit configured to determine whether the reconfigurable computing apparatus is operating in the first mode or the second mode;
a second memory accessing unit configured to, in response to the mode determining unit determining that the reconfigurable computing apparatus is operating in the second mode, be activated and access the second memory to fetch the instruction word comprising the plurality of the second instructions that can be processed in parallel from the second memory; and
a first memory accessing unit configured to, in response to the mode determining unit determining that the reconfigurable computing apparatus is operating in the second mode, be activated and access the first memory to store the debugging trace data in the first memory.

8. The second memory controller of claim 7, wherein the second memory accessing unit is further configured to be deactivated in response to the mode determining unit determining that the reconfigurable computing apparatus is operating in the first mode.

9. The second memory controller of claim 7, wherein the first memory accessing unit is further configured to be deactivated in response to the mode determining unit determining that the reconfigurable computing apparatus is operating in the first mode.

10. The second memory controller of claim 7, further comprising a data output unit configured to select from the first memory debugging trace data chosen by a debugging apparatus, and output the selected debugging trace data to the debugging apparatus.

11. A reconfigurable computing apparatus capable of processing debugging trace data, the reconfigurable computing apparatus comprising:
a processor configured to switch between a first mode of the reconfigurable computing apparatus and a second mode of the reconfigurable computing apparatus, wherein in the first mode, first instructions associated with a loop operation are executed, and in the second mode, second instructions associated with a general operation other than the loop operation that can be processed in parallel are executed;
a reconfigurable unit comprising a plurality of processing elements configured to execute the first instructions in the first mode and execute the second instructions in the second mode, the execution of the first instructions being mutually exclusive with the execution of the second instructions;
a first memory configured to store configuration information for use in configuring a connection path between the processing elements of the reconfigurable unit in the first mode;
a second memory configured to have an instruction word fetched therefrom in the second mode, the instruction word comprising a plurality of the second instructions associated with the general operation other than the loop operation that can be processed in parallel;
a first memory controller configured to, in response to the processor switching to the first mode, read the configuration information from the first memory, and store the debugging trace data in the second memory; and
a second memory controller configured to, in response to the processor switching to the second mode, fetch the instruction word from the second memory, and store the debugging trace data in the first memory.

12. The reconfigurable computing apparatus of claim 11, wherein the first memory controller comprises:
a mode determining unit configured to determine whether the reconfigurable computing apparatus is operating in the first mode or the second mode;
a first memory accessing unit configured to, in response to the mode determining unit determining that the reconfigurable computing apparatus is operating in the first mode, be activated and access the first memory to read the configuration information from the first memory; and
a second memory accessing unit configured to, in response to the mode determining unit determining that the reconfigurable computing apparatus is operating in the first mode, be activated and access the second memory to store the debugging trace data in the second memory.

13. The reconfigurable computing apparatus of claim 12, wherein the first memory accessing unit is further configured to be deactivated in response to the mode determining unit determining that the reconfigurable computing apparatus is operating in the second mode.

14. The reconfigurable computing apparatus of claim 12, wherein the second memory accessing unit is further configured to be deactivated in response to the mode determining unit determining that the reconfigurable computing apparatus is operating in the second mode.

15. The reconfigurable computing apparatus of claim 12, wherein the first memory controller further comprises a data output unit configured to select from the second memory debugging trace data chosen by a debugging apparatus, and output the selected debugging trace data to the debugging apparatus.

16. The reconfigurable computing apparatus of claim 11, wherein the second memory controller comprises:
a mode determining unit configured to determine whether the reconfigurable computing apparatus is operating in the first mode or the second mode;
a second memory accessing unit configured to, in response to the mode determining unit determining that the reconfigurable computing apparatus is operating in the second mode, be activated and access the second memory to fetch the instruction word comprising the plurality of the second instructions associated with the general operation other than the loop operation that can be processed in parallel from the second memory; and
a first memory accessing unit configured to, in response to the mode determining unit determining that the reconfigurable computing apparatus is operating in the second mode, be activated and access the first memory to store the debugging trace data in the first memory.

17. The reconfigurable computing apparatus of claim 16, wherein the second memory accessing unit is further configured to be deactivated in response to the mode determining unit determining that the reconfigurable computing apparatus is operating in the first mode.

18. The reconfigurable computing apparatus of claim 16, wherein the first memory accessing unit is further configured to be deactivated in response to the mode determining unit determining that the reconfigurable computing apparatus is operating in the first mode.

19. The reconfigurable computing apparatus of claim 16, wherein the second memory controller further comprises a data output unit configured to select from the first memory debugging trace data chosen by a debugging apparatus, and output the debugging trace data to the debugging apparatus.

20. A method of processing debugging trace data in a reconfigurable computing apparatus, the method comprising:
in a first mode of the reconfigurable computing apparatus, storing debugging trace data generated by execution of first instructions in the first mode of the reconfigurable computing apparatus in a second memory configured to store an instruction word comprising a plurality of second instructions in a second mode of the reconfigurable computing apparatus; and
in the second mode of the reconfigurable computing apparatus, storing debugging trace data generated by execution of the second instructions in the second mode of the reconfigurable computing apparatus in a first memory configured to store configuration information for use in configuring a connection path between processing elements of a reconfigurable unit in the first mode.

21. The method of claim 20, wherein the first instructions are associated with a loop operation; and
the second instructions are associated with a general operation other than the loop operation and can be processed in parallel.

22. The method of claim 20, wherein the reconfigurable computing apparatus switches between the first mode and the second mode;
the method further comprises determining whether the reconfigurable computing apparatus is operating in the first mode or the second mode;
the storing of the debugging trace data in the second memory is performed in response to a result of the determining being that the reconfigurable computing apparatus is operating in the first mode; and
the storing of the debugging trace data in the first memory is performed in response to a result of the determining being that the reconfigurable computing apparatus is operating in the second mode.
